(19) United States
(12) Patent Application Publication
(10) Pub. No.: US 2010/0061089 A1
(43) Pub. Date: Mar. 11, 2010

(54) FLEXIBLE LIGHT STRIP

(76) Inventors: Pao-Lung Lin, Taipei (TW); Ming-Kai Chan, Sanchong City (TW)

Correspondence Address: HDLS Patent & Trademark Services, P.O. BOX 220746, CHANTILLY, VA, 20153-0746, US

(21) Appl. No.: 12/208,433

(22) Filed: Sep. 11, 2008

(51) Int. Cl. F21S 4/00

(52) U.S. Cl. 362/218

(57) ABSTRACT

A flexible light strip includes an electrical-conductive layer, a plurality of light-emitting units, an insulating layer, and a heat-conducting layer. The light-emitting units are adhered to the electrical-conductive layer and are electrically connected thereto. The insulating layer is overlapped on one surface of the electrical-conductive layer. The insulating layer is provided with a plurality of through holes for allowing the light-emitting units to pass through. The heat-conducting layer is adhered on the electrical-conductive layer. Due to its flexibility, the light strip of the present invention can be bent and adhered to articles of various shapes according to practical demands.

### BACKGROUND OF THE INVENTION

1. Field of the Invention

The present invention relates to a light strip, and in particular to a flexible light strip.

2. Description of Prior Art

In a location that needs to be marked or warned, such as an automatic gate machine used in a parking lot, a rod of the gate machine is usually coated with a light-reflecting paint in order to make a driver to see the opening and closing of the gate clearly. The headlight illuminates the gate and the light-reflecting paint on the rod of the gate will reflect the light to the driver, so that the driver can see the gate clearly. However, since the light-reflecting paint may fall off after a period of time, the gate has to be coated with the light-reflecting paint periodically, which is troublesome and wastes manpower. On the other hand, the light-reflecting paint is a passive protection. More specifically, only when the gate is illuminated by the headlight of the car, the gate will be shining. Therefore, the warning effect of such a gate coated with a light-reflecting paint is insufficient.

In view of the above, a conventional light strip is proposed, which includes an outer frame, a circuit board, and a plurality of light-emitting units. The light-emitting units are electrically connected with the circuit board. The circuit board and the light-emitting units are accommodated in the outer frame. The light strip is adhered to the gate and shines to provide an active protection. However, such a light strip still has some problems in use. Since the light strip cannot be bent, both end surfaces of the gate have to be provided with the light strip respectively, which increases the cost. Furthermore, adhering light strips on both end surfaces of the gate will inevitably increase the total weight of the gate, which increases the burden of the gate.

Therefore, it is an important issue for those skilled in this art to overcome the above problems.

### SUMMARY OF THE INVENTION

The present invention is to provide a flexible light strip. Due to its flexibility, the light strip of the present invention can be bent and adhered to articles of various shapes based on the practical demands.

The present invention is to provide a flexible light strip, which includes an electrical-conductive layer, a plurality of light-emitting units, an insulating layer, and a heat-conducting layer. The light-emitting units are adhered to the electrical-conductive layer and are electrically connected thereto. The insulating layer is overlapped on one surface of the electrical-conductive layer. The insulating layer is provided with a plurality of through holes for allowing the light-emitting units to pass through. The heat-conducting layer is adhered on the electrical-conductive layer.

### BRIEF DESCRIPTION OF THE DRAWINGS

FIG. 1 is an exploded perspective view of the present invention;

FIG. 2 is an assembled perspective view of the present invention;

FIG. 3 is a cross-sectional view along the line 3-3 in FIG. 2;

FIG. 4 is a schematic view showing another embodiment of the present invention; and

FIG. 5 is a schematic view showing a further embodiment of the present invention.

### DETAILED DESCRIPTION OF THE INVENTION

The detailed description and technical contents of the present invention will be explained with reference to the accompanying drawings. However, the drawings are illustrative only but not used to limit the present invention.

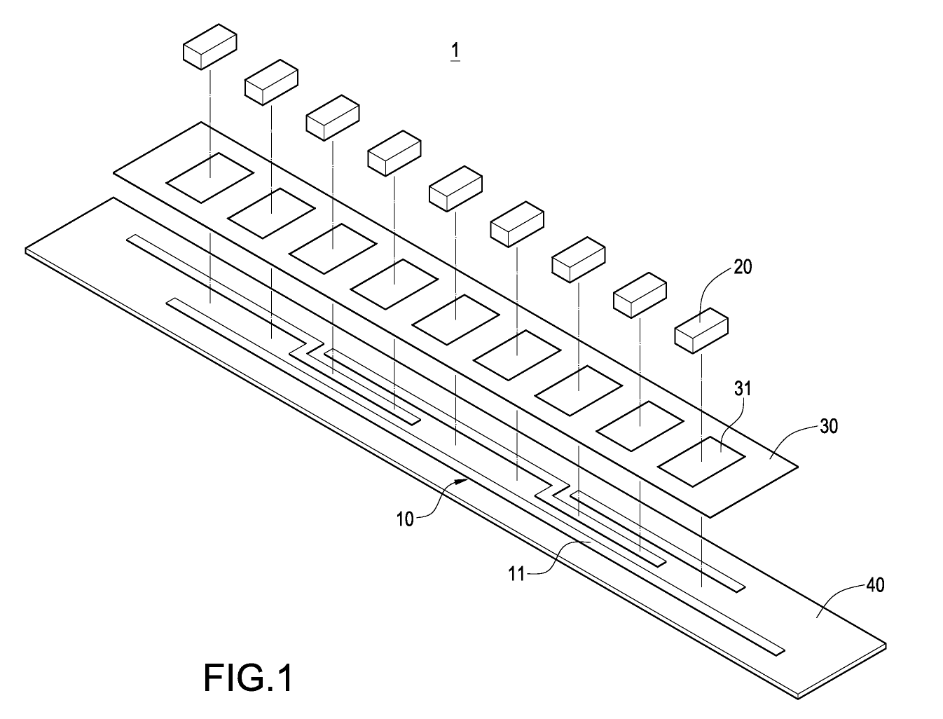

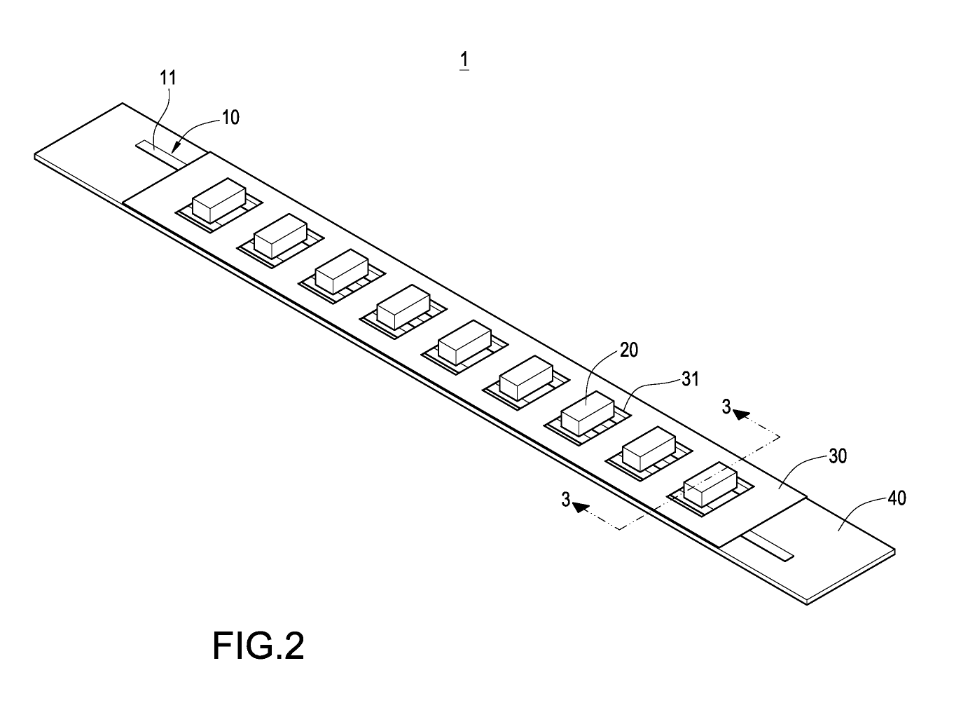

Please refer to FIG. 1 and FIG. 2, which are an exploded perspective view and an assembled perspective view of the present invention respectively. The present invention provides a flexible light strip, which includes an electrical-conductive layer 10, a plurality of light-emitting units 20, an insulating layer 30 and a heat-conducting layer 40.

The electrical-conductive layer 10 can be bent, wound and folded freely. It can be arranged in various manners according to the desired space layout, and it can move, extend and retreat arbitrarily in a three-dimensional space. Further, the electrical-conductive layer 10 is capable of dissipating heat, and can be soldered and connected easily. The electrical-conductive layer 10 is constituted of a plurality of copper foil circuits 11. The copper coil circuits 11 are electrically connected with a plurality of electric wires (not shown). The electric wires are used to provide power.

The insulating layer 30 is overlapped on a surface of the electrical-conductive layer 10. The insulating layer 30 is provided with a plurality of through holes 31. The insulating layer 30 is made of electrical nonconductive materials. The light-emitting unit 20 can be a light-emitting diode. The light-emitting unit 20 is fixedly and electrically connected to the electrical-conductive layer 10 and also is electrically connected to the copper foil circuit 11. The through hole 31 allows the light-emitting unit 20 to be accommodated therein. The outer surface of the light-emitting unit 20 is exposed to the insulating layer 30.

The heat-conducting layer 40 is adhered on the electrical-conductive layer 10. The heat-conducting layer 40 is used to conduct the heat generated by the light-emitting units 20 and the electrical-conductive layer 10, thereby protecting the light-emitting units 20 and the electrical-conductive layer 10 from being overheated to suffer damage. The insulating layer 30 and the heat-conducting layer 40 are both formed into a piece.

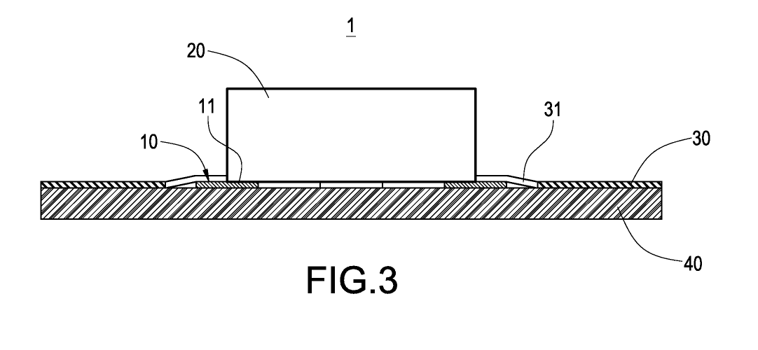

Please refer to FIG. 3, which is a cross-sectional view along the line 3-3 in FIG. 2. The electrical-conductive layer 10 is sealed by the insulating layer 30, thereby avoiding the electrical-conductive layer 10 from being exposed to the outside to generate a short circuit. Further, the electrical-conductive layer 10 can be thus protected from suffering damage to generate a broken circuit. The bottom surface of the electrical-conductive layer 10 is sealed by the heat-conducting layer 40, thereby protecting the electrical-conductive layer 10 and conducting the heat generated by the electrical-conductive layer 10 and the light-emitting units 20.

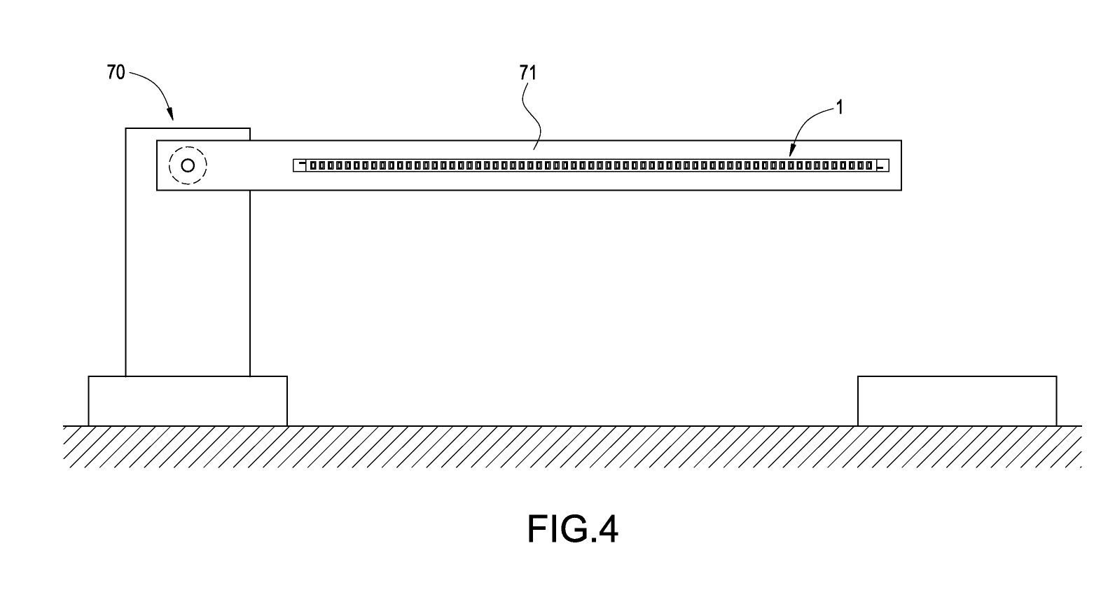

Please refer to FIG. 4, which is a schematic view showing another embodiment of the present invention. The present invention can be applied to a gate machine 70 that is provided at an entrance or exit in a parking lot. The gate machine 70 has a gate 71 that can be opened and closed vertically. The flexible light strip 1 is adhered to one end surface of the gate 71 directly, thereby replacing the light-reflecting paint used in prior art. The light strip 1 can shine automatically to provide an active protection, thereby achieving a better warning effect.

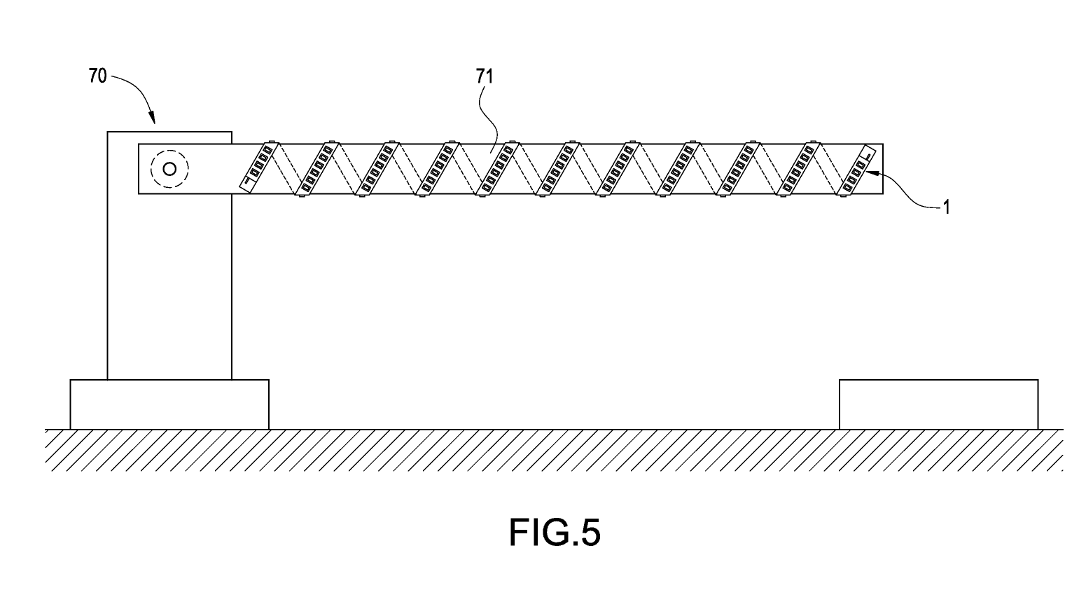

Please refer to FIG. 5, which is a schematic view showing a further embodiment of the present invention. Since the flexible light strip 1 can be bent freely, the light strip 1 can be wound on the gate 71 directly. In this way, only one light strip 1 can make both end surfaces of the gate shining, which increases its convenience in use.

To sum up the above, the flexible light strip of the present invention has advantages as follows.

(I) The flexible light strip 1 can illuminate and shine automatically, thereby providing a better warning effect and enhancing its performance.

(II) Since the flexible light strip 1 can be bent, wound and folded, it can be applied to various cases, which increases its practicability and convenience a lot.

According to the above, the flexible light strip of the present invention really has industrial applicability, novelty and inventive steps. Furthermore, the present invention has not been seen in products of the same kind, or let in public use. Therefore, the present invention indeed conforms to the requirements for a utility model patent.

What is claimed is:

1. A flexible light strip, comprising:
an electrical-conductive layer;
a plurality of light-emitting units adhered to the electrical-conductive layer and electrically connected thereto;
an insulating layer overlapped on one surface of the electrical-conductive layer, the insulating layer being provided with a plurality of through holes for allowing the light-emitting units to pass through; and
a heat-conducting layer adhered on the electrical-conductive layer.

2. The flexible light strip according to claim 1, wherein the electrical-conductive layer is a plurality of copper foil circuits, and the light-emitting units are adhered to the copper foil circuits.

3. The flexible light strip according to claim 2, wherein the light-emitting unit is a light-emitting diode.

4. The flexible light strip according to claim 3, wherein an outer surface of the light-emitting diodes is exposed to the insulating layer.

5. The flexible light strip according to claim 4, wherein the insulating layer and the heat-conducting layer are both formed into a piece.
